(19) United States
(12) Patent Application Publication
(10) Pub. No.: US 2017/0185996 A1
(43) Pub. Date: Jun. 29, 2017

(54) METHOD FOR ADDING A NEW PRODUCT FUNCTIONALITY TO A CUSTOMER'S DIGITAL CARD

(71) Applicant: MasterCard International Incorporated, Purchase, NY (US)

(72) Inventor: Pravin Parekh, Pune (IN)

(21) Appl. No.: 15/377,561

(22) Filed: Dec. 13, 2016

(30) Foreign Application Priority Data
Dec. 29, 2015 (SG) 10201510742S

(51) Int. Cl. G06Q 20/34; G06Q 20/10; H04M 1/725; H04W 4/02; G06K 19/07; G06Q 20/36

(52) U.S. Cl. CPC G06Q 20/3563; G06K 19/0723; G06Q 20/36; H04M 1/72583; H04W 4/021; G06Q 20/1085

(57) ABSTRACT

A method for adding a new product functionality to a customer's digital card which has been provisioned on a client application, the method comprising the steps of creating an association between a primary account number of the digital card and an account associated with the new product functionality and setting configuration parameters in a server in relation to the primary account number of the digital card to activate a primary feature associated with the new product functionality, the primary feature associated with the new product functionality capable of initiating data access to the account associated with the new product functionality. The method further comprises the step of initiating an update to the client application on a mobile device such that the digital card is provided with the primary feature associated with the new product functionality.

### CROSS-REFERENCE TO RELATED APPLICATION

This application is a U.S. National Stage filing under 35 U.S.C. §119, based on and claiming benefit of and priority to SG Patent Application No. 102015107425 filed Dec. 29, 2015.

### TECHNICAL FIELD

The following discloses a method for adding a new product functionality to a customer's digital card.

### BACKGROUND

With our society's constant desire and push for integration and enhancing customer convenience, “combo” cards or “multiuse” cards are becoming more and more prevalent. These multi-functional cards differ from the more conventional uni-functional cards in that a single multi-functional card has multiple product functionalities, effectively replacing a plurality of uni-functional cards with a single plastic card.

For example, there are multi-functional cards that incorporate a credit card product functionality as well as a debit card product functionality. How it works is that the debit card product functionality of the multi-functional card is linked to the customer's checking account, while the credit card product functionality of the multi-functional card is linked to the credit card issuer, which can be a financial institution, such as a bank or credit company. When making purchases, the customer has an option to pay using “credit” or “debit”. If the customer chooses debit, the funds are debited from the customer's checking account. If the customer chooses credit, the cost of the item is charged to the customer's line of credit. The customer therefore has the luxury of making smaller purchases with the debit card product functionality, while making larger purchases with the credit card product functionality to pay them off over time, all with a single plastic card.

There are also multi-functional cards that incorporate a transit card product functionality with a debit card product functionality. When using public transport, these multi-functional plastic cards can be tapped at the turnstile and the fare will be deducted from a stored value in the transit card product functionality. An added synergistic effect could be that when the turnstile reader registers a low balance in the stored value in the transit card product functionality, the debit card product functionality will automatically top up the stored value in the transit card product functionality using funds from the checking account linked to the debit card product functionality.

Multi-functional cards are indeed useful and are superior to uni-functional cards in robustness and functionality. It is therefore desired that new product functionalities can be added to existing cards (to make them multi-functional) in an easy and efficient way to provide customers access to these new product functionalities.

However, at present, it is difficult to add new product functionalities to existing cards. This is because existing cards are usually in the form of physical plastic cards. Therefore, for a bank or credit company to add a new product functionality to an existing card for a customer, the bank or credit company would have to create a new physical card having the same primary account number as the existing card, but with the added product functionality, and reissue the new physical card to the customer, usually by post or mail. The existing card will then be deactivated and the customer will be asked to destroy it. Therefore, the prevailing practice of adding product functionality to cards is slow, tedious and not instantaneous. In this day and age where customers are more demanding in aspects of speed, efficiency and convenience, any slight delay in the provision of services may lead to customer dissatisfaction.

Therefore, there is a need for a novel method for adding a new product functionality to a customer's existing card in a manner that is both instantaneous and efficient.

Furthermore, other desirable features and characteristics will become apparent from the subsequent detailed description and the appended claims, taken in conjunction with the accompanying drawings and this background of the disclosure.

### SUMMARY

According to a first aspect of the invention, a computer implemented method for adding a new product functionality to a customer's digital card is described, the digital card having an existing product functionality, the digital card having been provisioned on a client application installed on a mobile device, and the digital card having a primary account number stored at a server. The computer implemented method comprising the steps of creating with a platform, an association between the primary account number of the digital card and an account associated with the new product functionality; setting with the platform, configuration parameters in the server in relation to the primary account number of the digital card to activate a primary feature associated with the new product functionality, the primary feature associated with the new product functionality capable of initiating data access to the account associated with the new product functionality; and initiating with the platform, an update to the client application on the mobile device such that the digital card is provided with the primary feature associated with the new product functionality.

Preferably, the computer implemented method further comprises the steps of setting with the platform, configuration parameters in the server in relation to the primary account number of the digital card to activate at least one auxiliary feature associated with the new product functionality, the at least one auxiliary feature associated with the new product functionality capable of initiating data access to the account associated with the new product functionality; and initiating with the platform, another update to the client application on the mobile device such that the digital card is provided with the at least one auxiliary feature associated with the new product functionality.

Preferably, the at least one auxiliary feature relates to non-transactional functions or transactional functions.

Preferably, the client application is a digital wallet.

Preferably, the new product functionality is anyone of the following: debit card product functionality, credit card product functionality, forex card product functionality, prepaid card product functionality, transit card product functionality, loyalty card product functionality, gift card product functionality and corporate card product functionality.

Preferably, the computer implemented method further comprises the step of accessing the account associated with the new product functionality to retrieve data, in response to a selection of a feature tab on a product functionality interface rendered on a display interface of the mobile device.

Preferably, the computer implemented method further comprises the step of sending the retrieved data to the mobile device for display on the display interface.

According to a second aspect of the invention, a platform for adding a new product functionality to a customer's digital card is described, the digital card having an existing product functionality, the digital card having been provisioned on a client application installed on a mobile device, and the digital card having a primary account number stored in a server. The platform comprising at least one processor configured to create an association between the primary account number of the digital card and an account associated with the new product functionality; set configuration parameters in the server in relation to the primary account number of the digital card, to activate a primary feature associated with the new product functionality, the primary feature associated with the new product functionality capable of initiating data access to the account associated with the new product functionality; and initiate an update to the client application on the mobile device such that the digital card is provided with the primary feature associated with the new product functionality.

Preferably, the at least one processor is further configured to set configuration parameters in the server in relation to the primary account number of the digital card, to activate at least one auxiliary feature associated with the new product functionality, the at least one auxiliary feature associated with the new product functionality capable of initiating data access to the account associated with the new product functionality; and initiate another update to the client application on the mobile device such that the digital card is provided with the at least one auxiliary feature associated with the new product functionality.

Preferably, the at least one auxiliary feature relates to non-transactional functions or transactional functions.

Preferably, the client application is a digital wallet.

Preferably, the new product functionality is anyone of the following: debit card product functionality, credit card product functionality, forex card product functionality, prepaid card product functionality, transit card product functionality, loyalty card product functionality, gift card product functionality and corporate card product functionality.

Preferably, the at least one processor is further configured to access the account associated with the new product functionality to retrieve data, in response to a selection of a feature tab on a product functionality interface rendered on a display interface of the mobile device.

Preferably, the at least one processor is further configured to send the retrieved data to the mobile device for display on the display interface.

According to a third aspect of the invention, a computer implemented method for receiving a new product functionality for a customer's digital card is described, the digital card having an existing product functionality, the digital card having been provisioned on a client application installed on a mobile device, and the digital card having a primary account number stored in a server. The computer implemented method comprising the step of receiving an update on the client application from a platform such that the digital card is provided with a primary feature associated with the new product functionality, the primary feature associated with the new product functionality having been activated by the setting of configuration parameters in the server in relation to the primary account number of the digital card, wherein the primary feature associated with the new product functionality is capable of initiating data access to an account associated with the new product functionality.

Preferably, the computer implemented method further comprises the step of receiving another update on the client application from the platform such that the digital card is provided with at least one auxiliary feature associated with the new product functionality, the at least one auxiliary feature associated with the new product functionality having been activated by the setting of configuration parameters in the server in relation to the primary account number of the digital card, wherein the at least one auxiliary feature associated with the new product functionality is capable of initiating data access to the account associated with the new product functionality.

Preferably, the at least one auxiliary feature relates to non-transactional functions or transactional functions.

Preferably, the client application is a digital wallet.

Preferably, the computer implemented method further comprises the step of rendering a graphic representation of the digital card on a display interface of the mobile device.

Preferably, the computer implemented method further comprises the step of rendering selectable product tabs on the graphic representation of the digital card to allow selection of the new product functionality.

Preferably, the computer implemented method further comprises the step of launching a product functionality interface in response to a selection of one of the product tabs.

Preferably, the computer implemented method further comprises the step of rendering selectable feature tabs on the product functionality interface to allow selection of the primary feature or the at least one auxiliary feature associated with the new product functionality.

Preferably, the new product functionality is anyone of the following: debit card product functionality, credit card product functionality, forex card product functionality, prepaid card product functionality, transit card product functionality, loyalty card product functionality, gift card product functionality and corporate card product functionality.

Preferably, the computer implemented method further comprises the step of obtaining geolocation data; and automatically selecting the new product functionality based on the geolocation data.

Preferably, the geolocation data indicates that the mobile device is approaching an ATM (automated teller machine), and the new product functionality selected is the debit card product functionality.

Preferably, the geolocation data indicates that the mobile device is in a foreign country, and the new product functionality selected is the forex card product functionality.

Preferably, the geolocation data indicates that the mobile device is approaching a retail shop and the new product functionality selected is the credit card product functionality, the credit card product functionality having been previously used in the retail shop.

Preferably, the geolocation data indicates that the mobile device is approaching a retail shop and the new product functionality selected is the gift card product functionality, the gift card product functionality being associated with the retail shop.

Preferably, the computer implemented method further comprises the step of utilizing the geolocation data to perform the at least one auxiliary feature associated with the new product functionality.

Preferably, the at least one auxiliary feature associated with the new product functionality provides the customer with the location of an ATM within the vicinity of the mobile device.

According to a fourth aspect of the invention, a mobile device for receiving a new product functionality for a customer's digital card is described, the digital card having an existing product functionality, the digital card having been provisioned on a client application installed on the mobile device, and the digital card having a primary account number stored in a server. The mobile device comprising at least one processor configured to receive an update on the client application from a platform such that the digital card is provided with a primary feature associated with the new product functionality, the primary feature associated with the new product functionality having been activated by the setting of configuration parameters in the server in relation to the primary account number of the digital card, wherein the primary feature associated with the new product functionality is capable of initiating data access to an account associated with the new product functionality.

Preferably, the at least one processor is further configured to receive another update on the client application from the platform such that the digital card is provided with at least one auxiliary feature associated with the new product functionality, the at least one auxiliary feature associated with the new product functionality having been activated by the setting of configuration parameters in the server in relation to the primary account number of the digital card, wherein the at least one auxiliary feature associated with the new product functionality is capable of initiating data access to the account associated with the new product functionality.

Preferably, the at least one auxiliary feature relates to non-transactional functions or transactional functions.

Preferably, the client application is a digital wallet.

Preferably, the at least one processor is further configured to render a graphic representation of the digital card on a display interface of the mobile device.

Preferably, the at least one processor is further configured to render selectable product tabs on the graphic representation of the digital card to allow selection of the new product functionality.

Preferably, the at least one processor is further configured to launch a product functionality interface in response to the selection of one of the product tabs.

Preferably, the at least one processor is further configured to render selectable feature tabs on the product functionality interface to allow selection of the primary feature or the at least one auxiliary feature associated with the new product functionality.

Preferably, the new product functionality is anyone of the following: debit card product functionality, credit card product functionality, forex card product functionality, prepaid card product functionality, transit card product functionality, loyalty card product functionality, gift card product functionality and corporate card product functionality.

Preferably, the at least one processor is further configured to obtain geolocation data; and automatically select the new product functionality based on the geolocation data.

Preferably, the geolocation data indicates that the mobile device is approaching an ATM (automated teller machine) and the new product functionality selected is the debit card product functionality.

Preferably, the geolocation data indicates that the mobile device is in a foreign country, and the new product functionality selected is the forex card product functionality.

Preferably, the geolocation data indicates that the mobile device is approaching a retail shop and the new product functionality selected is the credit card product functionality, the credit card product functionality having been previously used in the retail shop.

Preferably, the geolocation data indicates that the mobile device is approaching a retail shop and the new product functionality selected is the gift card product functionality, the gift card product functionality being associated with the retail shop.

Preferably, the at least one processor is further configured to utilize the geolocation data to perform the at least one auxiliary feature associated with the new product functionality.

Preferably, the at least one auxiliary feature associated with the new product functionality provides the customer with the location of an ATM within the vicinity of the mobile device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 shows a system in accordance with an embodiment of the invention.

FIG. 2 shows a method of providing a digital card with a product functionality to the customer.

FIG. 3 shows a method of adding a new product functionality to a customer's digital card in accordance with a preferred embodiment of the invention.

FIG. 4 shows a method of adding another new product functionality to a customer's digital card in accordance with a preferred embodiment of the invention.

FIG. 5 shows an exemplary graphic representation of a digital card being displayed on the client application on the mobile device.

FIG. 6 shows an exemplary debit card product functionality interface.

FIG. 7 shows an exemplary credit card product functionality interface.

FIG. 8 shows an exemplary forex card product functionality interface.

FIG. 9 shows an exemplary prepaid card product functionality interface.

FIG. 10 shows an exemplary transit card product functionality interface.

FIG. 11 shows an exemplary loyalty card product functionality interface.

FIG. 12 shows an illustration of a customer using the debit card product functionality of a digital card to make payment.

FIG. 13 shows an illustration of a customer using the credit card product functionality of a digital card to make payment.

FIG. 14 shows an exemplary platform for performing the functions in accordance with an embodiment of the invention.

FIG. 15 shows an exemplary mobile device for performing the functions in accordance with an embodiment of the invention.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the preferred embodiments to disclose a method for adding a new product functionality to a customer's digital card. This method is advantageous because it is an efficient and instantaneous way to add product functionalities. The customer will thus have immediate access to the new product functionalities, enhancing the overall customer experience. The method is also extremely scalable in that multiple product functionalities can be incrementally added to a single digital card.

Furthermore, the disclosed method of adding product functionalities is incremental, which is extremely beneficial to banks and credit issuers. Now banks can take a step-wise and risk averse approach in offering their products to customers. The bank can first offer to a new customer a digital card with a risk-free debit card product functionality. Upon assessing the customer's financial viability through the course of the historical transactions on the debit product and determining that the customer is not a credit risk, the bank will be able to now instantly offer the credit card product functionality to the customer without undue delay by adding the credit card product functionality to the card using embodiments of the disclosed method. Therefore the bank benefits by being able to assess the customer's financial viability before offering risky product functionalities, and the customer benefits in that he will have immediate access to the product functionalities without any undue delay.

In some embodiments, there is provided a method to be performed by a platform, the method comprising the steps of (1) creating with the platform, an association between the primary account number of a digital card and an account associated with the new product functionality, the digital card having been provisioned on a client application installed on a mobile device, and the primary account number of the digital card stored in a bank server; (2) setting with the platform, configuration parameters in the bank server in relation to the primary account number of the digital card to activate a primary feature associated with the new product functionality, the primary feature associated with the new product functionality capable of initiating data access to the account associated with the new product functionality; and (3) initiating with the platform, an update to the client application on the mobile device such that the digital card is provided with the primary feature associated with the new product functionality.

In some embodiments, auxiliary card features can be added to the digital card, which make supplementary functions which are relevant to the product available to the customer. Auxiliary card features could involve non-transactional or transactional functions, and may include features which allow customers to view debit balances, credit balances, transaction history or account activity, or to perform fund transfer etc. This provides added convenience as customers would not need to access a separate banking application to view credit or debit balances. Other auxiliary card features can also include due date for credit card bills and the breakdown of these credit card bills. Even further still, as all the product functionalities share a single account number i.e. the primary account number of the digital card, the bank can provide a single consolidated digital bank statement across all product functionalities to the customer. The customer would be able to retrieve this consolidated digital bank statement by activating one of the auxiliary card features.

In some embodiments, the method comprises setting with the platform, configuration parameters in the bank server in relation to the primary account number of the digital card to activate auxiliary features associated with the new product functionality, the auxiliary features associated with the new product functionality capable of initiating data access to the account associated with the new product functionality; and initiating with the platform, another update to the client application on the mobile device such that the digital card is provided with the auxiliary features associated with the new product functionality.

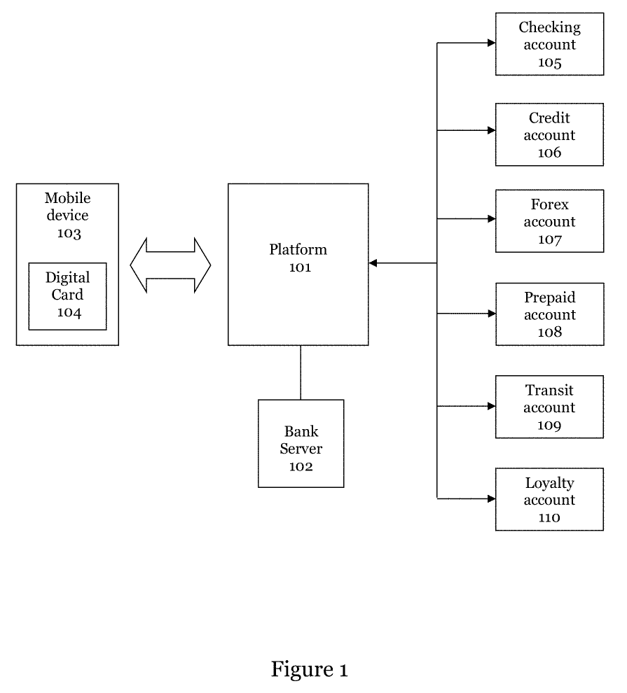

FIG. 1 shows a system in accordance with an embodiment of the invention.

The system comprises platform 101. Platform 101 could be operated by a financial institution, such as a bank or credit company. Platform 101 has access to bank server 102. Platform 101 is communicatively connected to mobile device 103. Mobile device 103 can be any computer device known in the art, e.g. smart phones, tablets, handhelds, laptops etc. Digital card 104 is provisioned on a client application installed on mobile device 103. Platform 101 is also communicatively connected to checking account 105, credit account 106, forex account 107, prepaid account 108, transit account 109 and loyalty account 110.

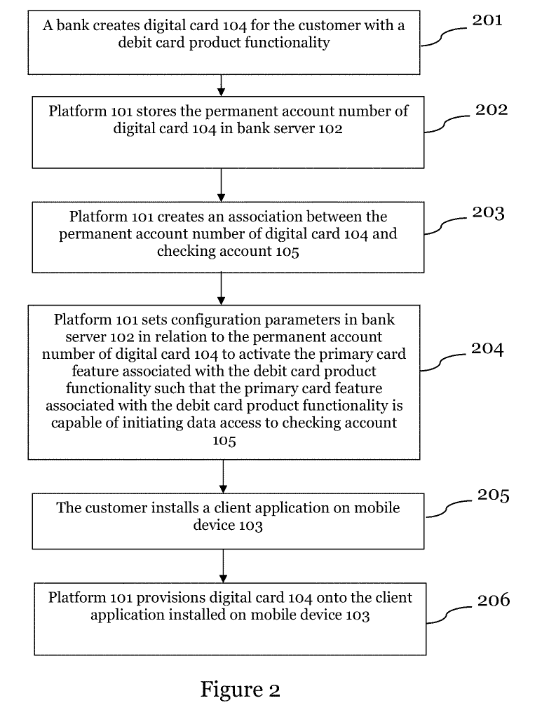

FIG. 2 shows a method of providing digital card 104 with a product functionality to the customer.

In step 201, a bank creates digital card 104 for the customer with a debit card product functionality. This could be in response to the customer opening up checking account 105. Digital card 104 has a primary account number.

In step 202, platform 101 stores the primary account number of digital card 104 in bank server 102.

In step 203, platform 101 creates an association between the primary account number of digital card 104 and checking account 105.

In step 204, platform 101 sets configuration parameters in bank server 102 in relation to the primary account number of digital card 104 to activate the primary card feature associated with the debit card product functionality such that the primary card feature associated with the debit card product functionality is capable of initiating data access to checking account 105. Primary card features relate to the primary or basic functions of the products. For example, the primary card feature for a debit card product functionality would be the ability to debit funds from checking account 105 to make payment for a transaction. In setting the configuration parameters, digital card 104 would have access and permission to use the funds in checking account 105 via platform 101 to make payment for a transaction.

In step 205, the customer installs a client application on mobile device 103.

Preferably, the client application is a digital wallet.

In step 206, platform 101 provisions digital card 104 onto the client application installed on mobile device 103. Platform 101 does this by pushing a software update to mobile device 103 to load digital card 104 onto the client application. The customer is now free to use the primary card feature of the debit card product functionality on digital card 104 via the client application on his mobile device 103.

Although the steps above depict digital card 104 having a debit card product functionality, this is for illustration purposes only, and one skilled in the art will recognize that digital card 104 being provided with any other product functionality is also possible.

In an embodiment, platform 101 can also set configuration parameters in bank server 102 in relation to the primary account number of digital card 104 to activate the auxiliary card features associated with the debit card product functionality such that the auxiliary card features are capable of initiating data access to checking account 105. Auxiliary card features provide supplementary functions which are relevant to the product and could relate to non-transactional functions. For example, auxiliary card features for the debit card product functionality could include a feature that allows the current balance in checking account 105 to be retrieved. Another auxiliary card feature for the debit card product functionality could be a feature that allows customers to view the last five transactions made on checking account 105. Auxiliary card features could also relate to transactional functions. One such example for the debit card product functionality could be a feature that allows customers to transfer/receive funds between checking account 105 and other bank accounts.

Auxiliary card features can be provided to the product functionalities on customer's request or upon the bank's approval. Alternatively, if the customer is a valued one who has a track record with the bank, platform 101 may also activate the auxiliary card features of the product functionality when activating the primary card feature of the product functionality. This provides added convenience as customers would not need to access a separate banking application to view debit balances, or transaction histories. Other auxiliary card features can also include due date for credit card bills and the breakdown of these credit card bills.

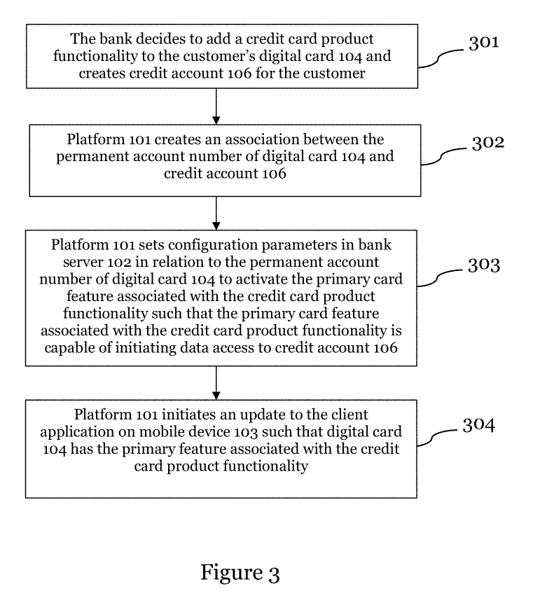

FIG. 3 shows a method of adding a new product functionality to a customer's digital card in accordance with a preferred embodiment of the invention.

In step 301, the bank decides to add a credit card product functionality to the customer's digital card 104 and creates credit account 106 for the customer. This could be due to the fact that the bank has reviewed the customer's relationship and has decided to offer a credit product to the customer.

In step 302, platform 101 creates an association between the primary account number of digital card 104 and credit account 106.

In step 303, platform 101 sets configuration parameters in bank server 102 in relation to the primary account number of digital card 104 to activate the primary card feature associated with the credit card product functionality such that the primary card feature associated with the credit card product functionality is capable of initiating data access to credit account 106. Primary card features relate to the primary or basic functions of the products. For example, the primary card feature for a credit card product functionality would be the ability to draw credit from credit account 106 to make payment for a transaction. In setting the configuration parameters, digital card 104 would have access and permission to use the available credit in credit account 106 via platform 101 to make payment for a transaction.

In step 304, platform 101 initiates an update to the client application on mobile device 103 such that digital card 104 has the primary feature associated with the credit card product functionality. The update to the client application may be transmitted from platform 101. Alternatively, the update to the client application may be transmitted from bank server 102 in response to instructions from platform 101. The customer is now free to use the primary feature of the credit card product functionality on digital card 104 via the client application on his mobile device 103. Preferably, the client application is a digital wallet.

Although the steps above depict a credit card product functionality being added to digital card 104, this is for illustration purposes only, and one skilled in the art will recognize that any other product functionality being added to digital card 104 is also possible.

In an embodiment, platform 101 can also set configuration parameters in bank server 102 in relation to the primary account number of digital card 104 to activate the auxiliary card features associated with the credit card product functionality such that the auxiliary card features are capable of initiating data access to credit account 106. In a similar manner, platform 101 initiates another update to the client application on mobile device 103 such that digital card 104 is provided with the auxiliary features associated with the credit card product functionality. This update to the client application may be transmitted from platform 101. Alternatively, the update to the client application may be transmitted from bank server 102 in response to instructions from platform 101. Auxiliary card features provide supplementary functions which are relevant to the product and could relate to non-transactional functions. For example, auxiliary card features for the credit card product functionality could include a feature that allows the available credit balance in credit account 106 to be retrieved. Another auxiliary card feature for the credit card product functionality could be a feature that allows customers to view offers, special discounts and promotions available to credit account 106 as provided by the bank. Auxiliary card features could also relate to transactional functions. One such example for the credit card product functionality could be a feature that allows customers to redeem the points accumulated in relation to credit account 106 when making payment for transactions. Another auxiliary card feature for the credit card product functionality could be a feature that allows customers to view outstanding bills in relation to credit account 106, and pay these bills, perhaps using funds from checking account 105.

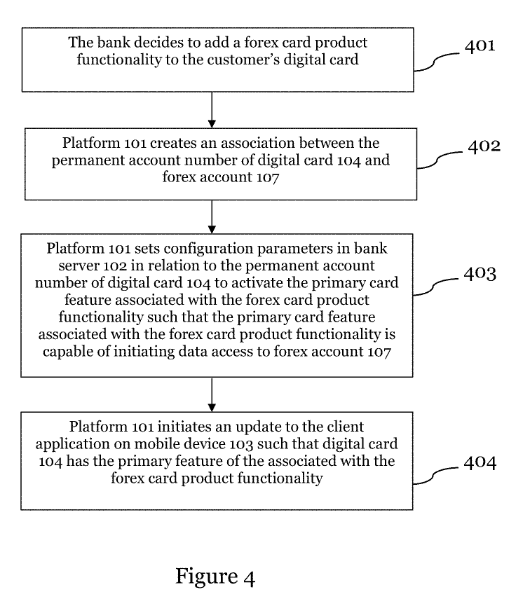

FIG. 4 shows a method of adding another new product functionality to a customer's digital card 104 in accordance with a preferred embodiment of the invention.

In step 401, the bank decides to add a forex card product functionality to the customer's digital card and creates forex account 107 for the customer. This could be due to the fact that the bank has reviewed the customer's relationship and has decided to offer a forex product to the customer.

In step 402, platform 101 creates an association between the primary account number of digital card 104 and forex account 107 in bank server 102.

In step 403, platform 101 sets configuration parameters in bank server 102 in relation to the primary account number of digital card 104 to activate the primary card feature associated with the forex card product functionality such that the primary card feature associated with the forex card product functionality is capable of initiating data access to forex account 107. Primary card features relate to the primary or basic functions of the products. For example, the primary card feature for a forex card product functionality would be the ability to draw funds from forex account 107 to make payment for a transaction. In setting the configuration parameters, digital card 104 would have access and permission to use the available funds in forex account 107 via platform 101 to make payment for a transaction.

In step 404, platform 101 initiates an update to the client application on mobile device 103 such that digital card 104 has the primary feature associated with the forex card product functionality. The update to the client application may be transmitted from platform 101. Alternatively, the update to the client application may be transmitted from bank server 102 in response to instructions from platform 101. Once the customer ensures that there are funds in forex account 107, the customer will be free to use the primary feature of the forex card product functionality on digital card 104 via the client application on his mobile device 103. Preferably, the client application is a digital wallet.

Although the steps above depict a forex card product functionality being added to digital card 104, this is for illustration purposes only, and one skilled in the art will recognize that any other product functionality being added to digital card 104 is also possible.

In an embodiment, platform 101 can also set configuration parameters in bank server 102 in relation to the primary account number of digital card 104 to activate the auxiliary card features associated with the forex card product functionality such that the auxiliary card features are capable of initiating data access to forex account 107. In a similar manner, platform 101 initiates another update to the client application on mobile device 103 such that digital card 104 is provided with the auxiliary features associated with the forex card product functionality. This update to the client application may be transmitted from platform 101. Alternatively, the update to the client application may be transmitted from bank server 102 in response to instructions from platform 101. Auxiliary card features provide supplementary functions which are relevant to the product and could relate to non-transactional functions. For example, auxiliary card features for the forex card product functionality could include a feature that allows the current balance in forex account 107 to be retrieved. Another auxiliary card feature for the forex card product functionality could be a feature that allows customers to view the currency of the funds stored in forex account 107. Another auxiliary card feature for the forex card product functionality could be a feature that allows customers to view offers, special discounts and promotions available to forex account 107 as provided by the bank.

Digital card 104 has been demonstrated to have a debit card product functionality, a credit card product functionality and a forex card product functionality. There is no limit to the number of product functionalities that can be added to digital card 104 save for practicality. It is possible to add, for example, a prepaid card product functionality, a transit card product functionality, a gift card product functionality and a loyalty card product functionality in the manner as described in the foregoing.

Therefore, what has been disclosed is an efficient and instantaneous method of adding product functionalities to digital card 104. The customer will thus have immediate access to the primary card features of the new product functionalities, enhancing the overall customer experience. The method is also extremely scalable in that multiple product functionalities can be added to a single digital card 104. Furthermore, auxiliary card features can be added to digital card 104, which make supplementary functions which are relevant to the product available to the customer. Auxiliary card features could involve non-transactional or transactional functions, and may include features which allow customers to view debit balances, credit balances, transaction history or account activity, or to perform fund transfer etc. This provides added convenience as customers would not need to access a separate banking application to view credit or debit balances. Other auxiliary card features can also include due date for credit card bills and the breakdown of these credit card bills. Even further still, as all the product functionalities share a single account number i.e. the primary account number of digital card 104, the bank can provide a single consolidated digital bank statement across all product functionalities to the customer. The customer would be able to retrieve this consolidated digital bank statement by activating one of the auxiliary card features.

Furthermore, the disclosed incremental manner of adding product functionalities is extremely beneficial to banks and credit issuers. Now banks can take a step-wise and risk adverse approach in offering their products to customers. The banks can first offer digital card 104 with a risk-free debit card product functionality to a new customer. Upon assessing the customer's financial viability through the course of the historical transactions on the debit product and determining that the customer is not a credit risk, the bank will be able to now instantly offer the credit card product functionality to the customer by adding the credit card product functionality to digital card 104. Therefore the bank benefits by being able to assess the customer's financial viability before offering risky product functionalities, and instantly pushing out the risky product functionalities to the customer once the decision has been made to offer it, and the customer benefits in that he will have immediate access to the product functionalities without any undue delay. The customer will therefore be spared from postage or collection delays which is inherent in physical delivery of physical cards. Furthermore, the speed at which banks can now offer new product functionalities to customers as a result of the disclosed method provides banks with a medium to upsell or cross sell new products faster.

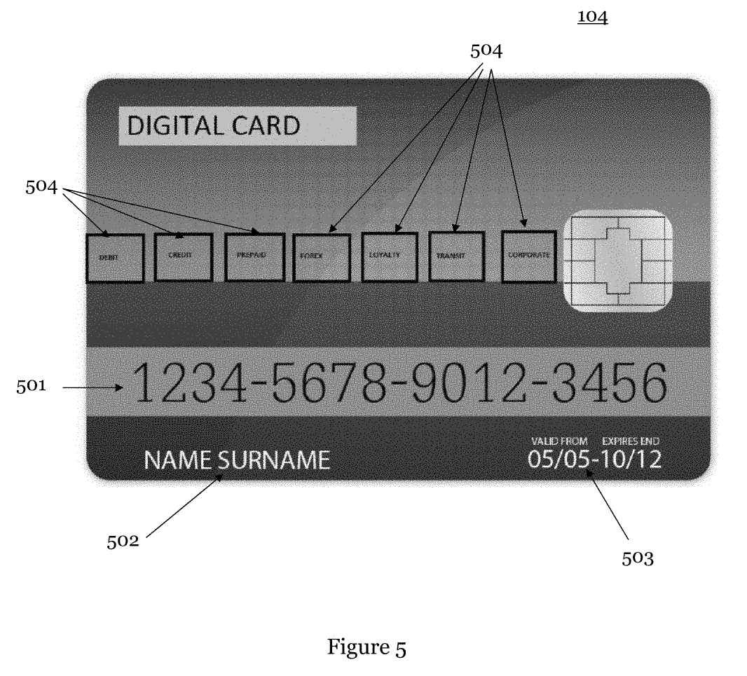

FIG. 5 shows an exemplary graphic representation of digital card 104 when it is displayed on the client application on mobile device 103. The graphic representation of digital card 104 displays primary account number 501 of digital card 104, identity 502 of the customer, validity-expiry period 503 of digital card 104. The graphic representation of digital card 104 can also display the product functionalities on digital card 104 in the form of product tabs 504. As shown in FIG. 5, the product tabs 504, displayed from left to right are “DEBIT”, “CREDIT”, “PREPAID”, “FOREX”, “LOYALTY”, “TRANSIT” and “CORPORATE” which correspond to debit card, credit card, prepaid card, forex card, loyalty card, transit card and corporate card product functionalities respectively. These product functionalities described are exemplary only, and it is envisioned that any existing or conceivable product card which is practical can be incorporated as a product functionality into digital card 104, for example, a gift card product functionality.

An indication means on the graphic representation of digital card 104 (not shown in FIG. 5) may be used to indicate to the customer which of the product functionalities are activated on digital card 104 and which are not. For example, if only the credit card product functionality and the debit card product functionality are activated on digital card 104, the text and font of “DEBIT” and “CREDIT” product tabs 504 may be enlarged or bolded or more pronounced, while the text and font for “PREPAID”, “FOREX”, “LOYALTY”, “TRANSIT” and “CORPORATE” product tabs 504 may be less discernible. The “DEBIT” and “CREDIT” product tabs 504 may also be highlighted or enlarged, to provide a visual cue to the customer that these product functionalities are active on digital card 104 and are available to the customer. Alternatively, the graphic representation of digital card 104 only displays product tabs 504 which correspond to activated product functionalities and do not display product tabs 504 which correspond to product functionalities which have not yet been activated. For example, if only the credit card product functionality and the debit card product functionality have been activated on digital card 104, only the “DEBIT” and “CREDIT” product tabs 504 will be displayed, while the “PREPAID”, “FOREX”, “LOYALTY”, “TRANSIT” and “CORPORATE” product tabs 504 will be hidden from the customer. However, if a new product functionality is added to digital card 104, for example a transit card product functionality, the “TRANSIT” product tab 504 will be displayed on the graphic representation of digital card 104 to indicate to the customer that the transit card product functionality has been activated and is now available for use. Product tabs 504 on the graphic representation of digital card 104 can be touch-screen activated or pressure sensitive.

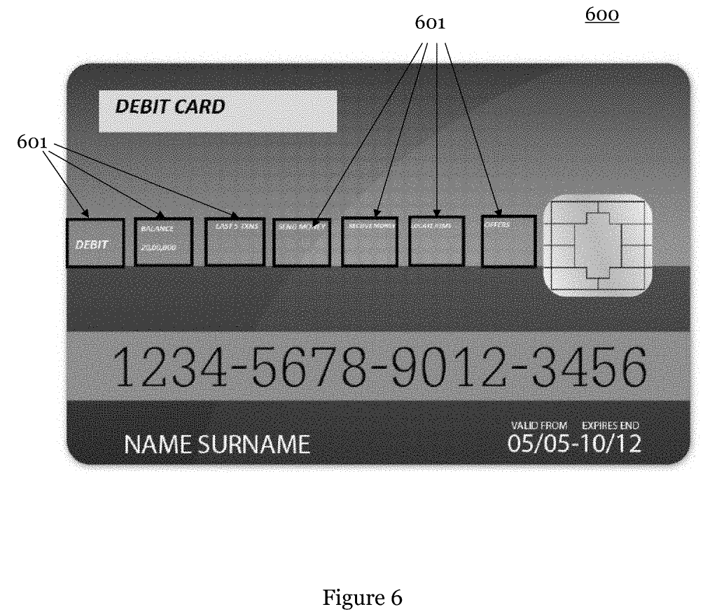

If the customer activates “DEBIT” product tab 504 to use the debit card product functionality, the graphic representation of digital card 104 will present a debit card product functionality interface 600 displaying a set of feature tabs 601 as shown in FIG. 6. Each feature tab 601 represents a specific feature in relation to the debit card product functionality available to the customer. As shown in FIG. 6, the feature tabs 601, displayed from left to right are, “DEBIT”, “BALANCE”, “LAST 5 TRANS”, “SEND MONEY”, “RECEIVE MONEY”, “LOCATE ATMS” and “OFFERS”. The “first” or “leftmost” feature tab (i.e. “DEBIT” feature tab 601) activates the primary feature of the debit card product functionality, which is the debiting of debit funds from checking account 105 to make payment for a transaction. The remaining feature tabs (i.e. “BALANCE” feature tab 601, “LAST 5 TRANS” feature tab 601, SEND MONEY″ feature tab 601, “RECEIVE MONEY” feature tab 601, “LOCATE ATMS” feature tab 601 and OFFERS″ feature tab 601) will activate the auxiliary features associated with the debit card product functionality. As long as the debit card product functionality is activated for digital card 104, the primary feature of the debit card product functionality will always be available to the customer and the “DEBIT” feature tab 601 will always be enabled. However, this is not so for the auxiliary features. Auxiliary features are optional add-on features which become available upon the bank's approval or upon a customer's request. Therefore, there can be instances where the feature tabs 601 which activate the auxiliary features associated with the debit card product functionality are not enabled despite the debit card product functionality being activated for digital card 104. Feature tabs 601 can be touch-screen activated or pressure sensitive.

If the customer wishes to use the primary card feature of debit card product functionality of digital card 104 to service a transaction, the customer simply needs to activate “DEBIT” feature tab 601. Funds will then be drawn from checking account 105 to service the transaction. And as for the auxiliary features associated with the debit card product functionality, if the customer activates “BALANCE” feature tab 601, data will be fetched from bank server 102 and the current balance in checking account 105 will be displayed to the customer. If the customer activates “LAST 5 TRANS” feature tab 601, the last five transactions made on checking account 105 will be displayed to the customer. If the customer activates “SEND MONEY” feature tab 601, the customer will have the capability via digital card 104 to send funds from checking account 105 to a specified recipient account. If the customer activates “RECEIVE MONEY” feature tab 601, the customer will have the capability via digital card 104 to receive funds from a specified recipient account and into checking account 105. If the customer activates “LOCATE ATMS” feature tab 601, the customer will have the capability via digital card 104 and a geolocation application on mobile device 103 to locate the automated teller machines in proximity to mobile device 103. If the customer activates “OFFERS” feature tab 601, the customer will receive via digital card 104 location-based offers, special discounts, promotions available to checking account 105 as provided by the bank. The feature tabs 601 and their associated primary feature and auxiliary features which are provided therein are exemplary only, and it is envisioned that any practical existing or conceivable feature in relation to debit cards can be incorporated into digital card 104.

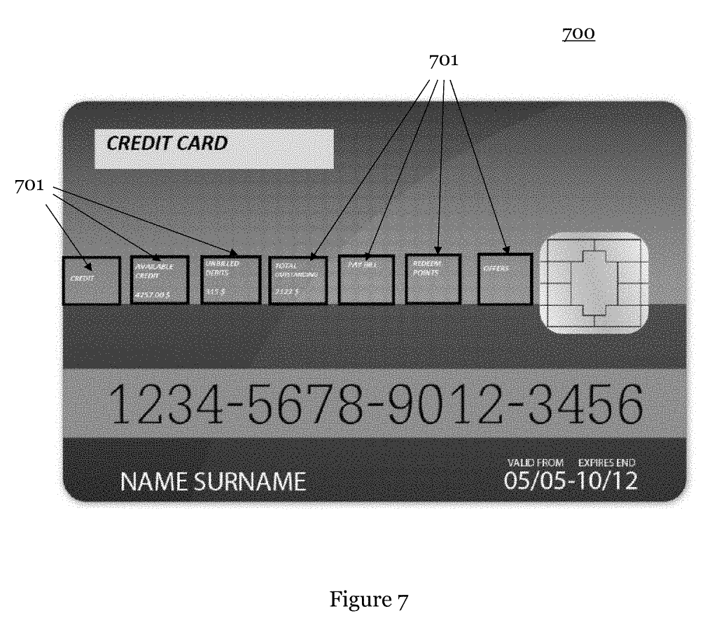

If the customer activates “CREDIT” product tab 504 to use the credit card product functionality, the graphic representation of digital card 104 will present a credit card product functionality interface 700 displaying a set of feature tabs 701 as shown in FIG. 7. Each feature tab 701 represents a specific feature in relation to the credit card product functionality available to the customer. As shown in FIG. 7, the feature tabs 701, displayed from left to right are, “CREDIT”, “AVAILABLE CREDIT”, “UNBILLED DEBITS”, “TOTAL OUTSTANDING”, “PAY BILL”, “REDEEM POINTS” and “OFFERS”. The “first” or “leftmost” feature tab (i.e. “CREDIT” feature tab 701) activates the primary feature of the credit card product functionality, which is drawing credit from credit account 106 to make payment for a transaction. The remaining feature tabs (i.e. “AVAILABLE CREDIT” feature tab 701, “UNBILLED DEBITS” feature tab 701, “TOTAL OUTSTANDING” feature tab 701, “PAY BILL” feature tab 701, “REDEEM POINTS” feature tab 701 and “OFFERS” feature tab 701) will activate the auxiliary features associated with the credit card product functionality. As long as the credit card product functionality is activated for digital card 104, the primary feature of the credit card product functionality will always be available to the customer and the “CREDIT” feature tab 701 will always be enabled. However, this is not so for the auxiliary features. Auxiliary features are optional add-on features which become available upon the bank's approval or upon a customer's request. Therefore, there can be instances where the feature tabs 701 which activate the auxiliary features associated with the credit card product functionality are not enabled despite the credit card product functionality being activated for digital card 104. Feature tabs 701 can be touch-screen activated or pressure sensitive.

If the customer wishes to activate the primary card feature of credit card product functionality of digital card 104 to service a transaction, the customer simply needs to activate “CREDIT” feature tab 701. Available credit will then be drawn from credit account 106 to service the transaction. And as for the auxiliary features associated with the credit card product functionality, if the customer activates “AVAILABLE CREDIT” feature tab 701, the available credit balance in credit account 106 will be displayed to the customer. If the customer activates “UNBILLED DEBITS” feature tab 701, the unbilled transactions made with credit account 106 will be displayed to the customer. If the customer activates “TOTAL OUTSTANDING” feature tab 701, the outstanding bill in relation to credit account 106 will be displayed to the customer. If the customer activates “PAY BILL” feature tab 701, the customer will have the capability via digital card 104 to pay the outstanding bill in relation to credit account 106. The customer may have the option of using the funds from checking account 105 to pay the outstanding bill in relation to credit account 106. If the customer activates “REDEEM POINTS” feature tab 701, the customer will have the capability via digital card 104 to redeem the points accumulated in relation to credit account 106. If the customer activates “OFFERS” feature tab 701, the customer will receive via digital card 104 the offers, special discounts, promotions available to credit account 106 as provided by the bank. The feature tabs 701 and their associated primary feature and auxiliary features which are provided therein are exemplary only, and it is envisioned that any practical existing or conceivable feature in relation to credit cards can be incorporated into digital card 104.

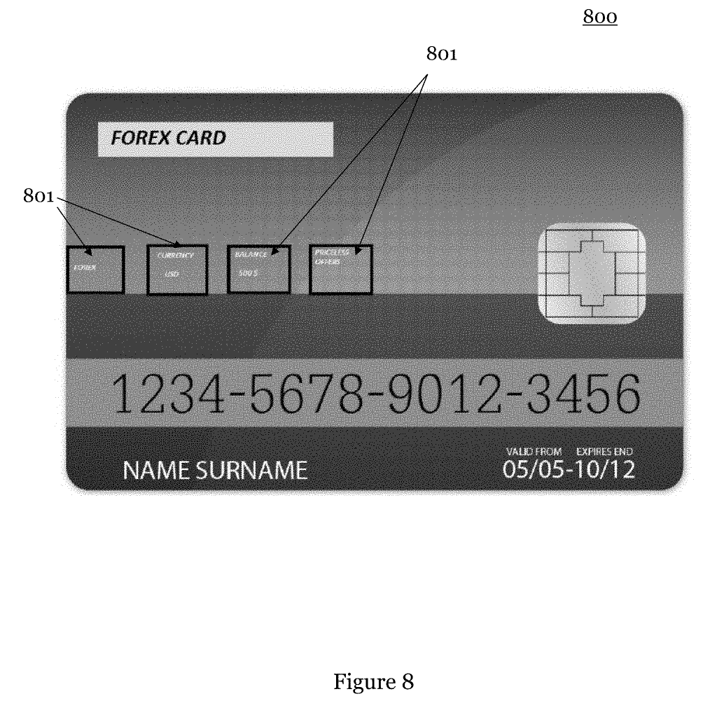

If the customer activates “FOREX” product tab 504 to use the forex card product functionality, the graphic representation of digital card 104 will present a forex card product functionality interface 800 displaying a set of feature tabs 801 as shown in FIG. 8. Each feature tab 801 represents a specific feature in relation to the forex card product functionality available to the customer. As shown in FIG. 8, the feature tabs 801, displayed from left to right are, “FOREX”, “CURRENCY”, “BALANCE” and “PRICELESS OFFERS”. The “first” or “leftmost” feature tab (i.e. “FOREX” feature tab 801) activates the primary feature of the forex card product functionality, which is the drawing of funds from forex account 107 to make payment for a transaction. The remaining feature tabs (i.e. “CURRENCY” feature tab 801, “BALANCE” feature tab 801, and “PRICELESS OFFERS” feature tab 801) will activate the auxiliary features associated with the forex card product functionality. As long as the forex card product functionality is activated for digital card 104, the primary feature of the forex card product functionality will always be available to the customer and the “FOREX” feature tab 801 will always be enabled. However, this is not so for the auxiliary features. Auxiliary features are optional add-on features which become available upon the bank's approval or upon a customer's request. Therefore, there can be instances where the feature tabs 801 which activate the auxiliary features associated with the forex card product functionality are not enabled despite the forex card product functionality being activated for digital card 104. Feature tabs 801 can be touch-screen activated or pressure sensitive.

If the customer wishes to activate the primary card feature of forex card product functionality of digital card 104 to service a transaction, the customer simply needs to activate “FOREX” feature tab 801. Funds will then be drawn from forex account 107 to service the transaction. And as for the auxiliary features associated with the forex card product functionality, if the customer activates “CURRENCY” feature tab 801, the currency of the funds stored in forex account 107 will be displayed to the customer. If the customer activates “BALANCE” feature tab 801, the current balance in forex account 107 will be displayed to the customer. If the customer activates “PRICELESS OFFERS” feature tab 801, the customer will receive via digital card 104 the offers, special discounts, promotions available to forex account 107 as provided by the bank. The feature tabs 801 and their associated primary feature and auxiliary features which are provided therein are exemplary only, and it is envisioned that any practical existing or conceivable feature in relation to forex cards can be incorporated into digital card 104.

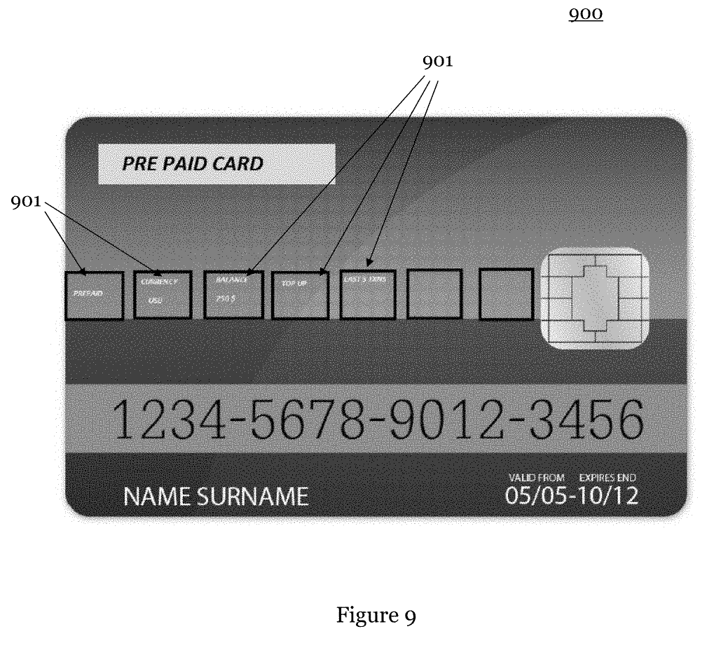

If the customer activates “PREPAID” product tab 504 to use the prepaid card product functionality, the graphic representation of digital card 104 will present a prepaid card product functionality interface 900 displaying a set of feature tabs 901 as shown in FIG. 9. Each feature tab 901 represents a specific feature in relation to the prepaid card product functionality available to the customer. As shown in FIG. 9, the feature tabs 901, displayed from left to right are, “PREPAID”, “CURRENCY”, “BALANCE”, “TOP UP” and LAST 5 TRANS″. The “first” or “leftmost” feature tab (i.e. “PREPAID” feature tab 901) activates the primary feature of the prepaid card product functionality, which is the drawing of funds from prepaid account 108 to make payment for a transaction. The remaining feature tabs (i.e. “CURRENCY” feature tab 901, “BALANCE” feature tab 901, “TOP UP” feature tab 901 and “LAST 5 TRANS” feature tab 901) will activate the auxiliary features associated with the prepaid card product functionality. As long as the prepaid card product functionality is activated for digital card 104, the primary feature of the prepaid card product functionality will always be available to the customer and the “PREPAID” feature tab 901 will always be enabled. However, this is not so for the auxiliary features. Auxiliary features are optional add-on features which become available upon the bank's approval or upon a customer's request. Therefore, there can be instances where the feature tabs 901 which activate the auxiliary features associated with the prepaid card product functionality are not enabled despite the prepaid card product functionality being activated for digital card 104. Feature tabs 901 can be touch-screen activated or pressure sensitive.

If the customer wishes to activate the primary card feature of prepaid card product functionality of digital card 104 to service a transaction, the customer simply needs to activate “PREPAID” feature tab 901. Funds will then be drawn from prepaid account 108 to service the transaction. And as for the auxiliary features associated with the prepaid card product functionality, if the customer activates “CURRENCY” feature tab 901, the currency of the funds stored in prepaid account 108 will be displayed to the customer. If the customer activates “BALANCE” feature tab 901, the current balance in prepaid account 108 will be displayed to the customer. If the customer activates “TOP UP” feature tab 901, the customer will have the capability via digital card 104 to add funds to prepaid account 108. The customer may have the option of adding the funds from checking account 105 into prepaid account 108. If the customer activates “LAST 5 TRANS” feature tab 901, the last five transactions made on prepaid account 108 will be displayed to the customer. The feature tabs 901 and their associated primary feature and auxiliary features which are provided therein are exemplary only, and it is envisioned that any practical existing or conceivable feature in relation to prepaid cards can be incorporated into digital card 104.

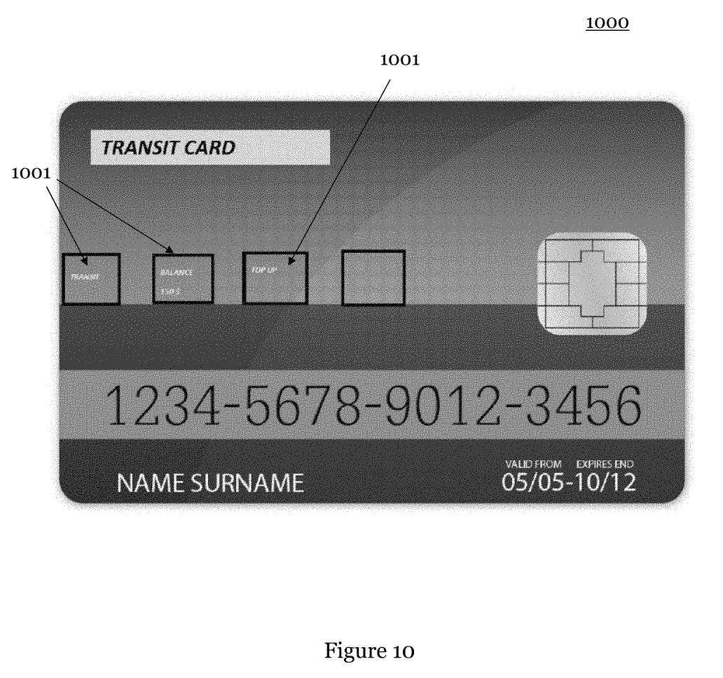

If the customer activates “TRANSIT” product tab 504 to use the transit card product functionality, the graphic representation of digital card 104 will present a transit card product functionality interface 1000 displaying a set of feature tabs 1001 as shown in FIG. 10. Each feature tab 1001 represents a specific feature in relation to the transit card product functionality available to the customer. As shown in FIG. 10, the feature tabs 1001, displayed from left to right are, “TRANSIT”, “BALANCE” and “TOP UP”. The “first” or “leftmost” feature tab (i.e. “TRANSIT” feature tab 1001) activates the primary feature of the transit card product functionality, which is the drawing of funds from transit account 109 to pay for public transport. The remaining feature tabs (i.e. “BALANCE” feature tab 1001 and “TOP UP” feature tab 1001) will activate the auxiliary features associated with the transit card product functionality. As long as the transit card product functionality is activated for digital card 104, the primary feature of the transit card product functionality will always be available to the customer and the “TRANSIT” feature tab 1001 will always be enabled. However, this is not so for the auxiliary features. Auxiliary features are optional add-on features which become available upon the bank's approval or upon a customer's request. Therefore, there can be instances where the feature tabs 1001 which activate the auxiliary features associated with the transit card product functionality are not enabled despite the transit card product functionality being activated for digital card 104. Feature tabs 1001 can be touch-screen activated or pressure sensitive.

If the customer wishes to activate the primary card feature of transit product functionality of digital card 104 to pay for public transport, the customer simply needs to activate “TRANSIT” feature tab 1001. Funds will then be drawn from transit account 109 to pay for the public transport. And as for the auxiliary features associated with the transit card product functionality, if the customer activates “BALANCE” feature tab 1001, the current balance in transit account 109 will be displayed to the customer. If the customer activates “TOP UP” feature tab 1001, the customer will have the capability via digital card 104 to add funds to transit account 109. The customer may have the option of adding the funds from checking account 105 into transit account 109. The feature tabs 1001 and their associated primary feature and auxiliary features which are provided therein are exemplary only, and it is envisioned that any practical existing or conceivable feature in relation to transit cards can be incorporated into digital card 104.

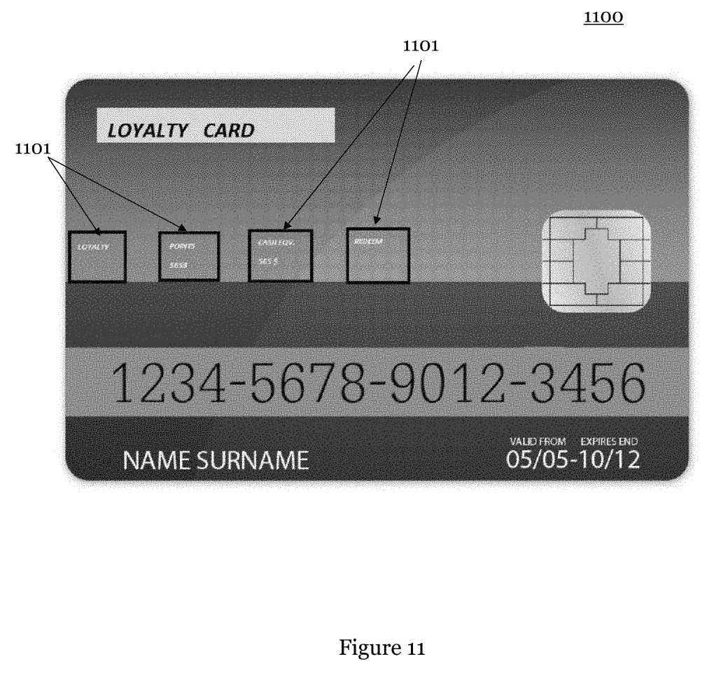

If the customer activates “LOYALTY” product tab 504 to use the loyalty card product functionality, the graphic representation of digital card 104 will present a loyalty card product functionality interface 1100 displaying a set of feature tabs 1101 as shown in FIG. 11. Each feature tab 1101 represents a specific feature in relation to the loyalty card product functionality available to the customer. As shown in FIG. 11, the feature tabs 1101, displayed from left to right are, “LOYALTY”, “POINTS”, “CASH EQV” and “REDEEM”. The “first” or “leftmost” feature tab (i.e. “LOYALTY” feature tab 1101) activates the primary feature of the loyalty card product functionality, which is the drawing of the cash equivalent of points from loyalty account 110 to service a transaction. The remaining feature tabs (i.e. “POINTS” feature tab 1101, “CASH EQV” feature tab 1101 and “REDEEM” feature tab 1101) will activate the auxiliary features associated with the loyalty card product functionality. As long as the loyalty card product functionality is activated for digital card 104, the primary feature of the loyalty card product functionality will always be available to the customer and the “LOYALTY” feature tab 1101 will always be enabled. However, this is not so for the auxiliary features. Auxiliary features are optional add-on features which become available upon the bank's approval or upon a customer's request. Therefore, there can be instances where the feature tabs 1101 which activate the auxiliary features associated with the loyalty card product functionality are not enabled despite the loyalty card product functionality being activated for digital card 104. Feature tabs 1101 can be touch-screen activated or pressure sensitive.

If the customer wishes to activate the primary card feature of loyalty product functionality of digital card 104 to service a transaction, the customer simply needs to activate “LOYALTY” feature tab 1101. The cash equivalent of points will then be drawn from loyalty account 110 to service the transaction. And as for the auxiliary features associated with the loyalty card product functionality, if the customer activates “POINTS” feature tab 1101, the current point balance in loyalty account 110 will be displayed to the customer. If the customer activates “CASH EQV” feature tab 1101, the cash equivalent of the current point balance in loyalty account 110 will be displayed to the customer. If the customer activates “REDEEM” feature tab 1101, the customer will have the capability via digital card 104 to redeem the points in loyalty account 110. The feature tabs 1101 and their associated primary feature and auxiliary features which are provided therein are exemplary only, and it is envisioned that any practical existing or conceivable feature in relation to loyalty cards can be incorporated into digital card 104.

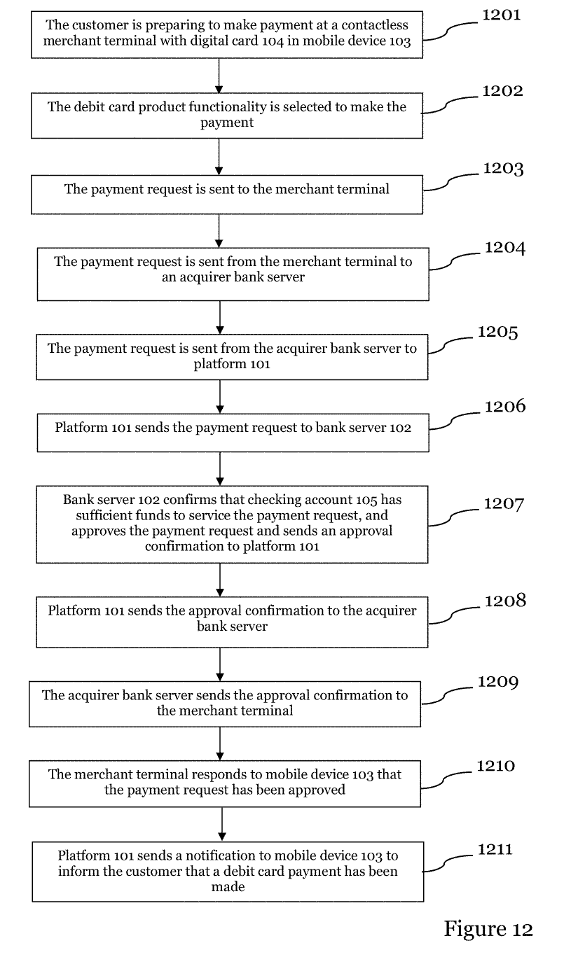

FIG. 12 shows an illustration of a customer using the debit card product functionality of digital card 104 to make payment.

In step 1201, the customer is preparing to make payment at a contactless merchant terminal with digital card 104 in mobile device 103. The customer has the option of using the debit card product functionality or the credit card product functionality to make the payment.

In step 1202, the debit card product functionality is selected to make the payment. The debit card functionality may be selected by the customer. The customer's selection of the debit card product functionality could be done via the graphic representation of digital card 104 as described above. The customer may have decided to use the debit card product functionality as the payment amount is small. Alternatively, the debit card functionality may be selected following a trigger by other applications on mobile device 103 (for example, a geolocation application). Alternatively, the debit card functionality may be selected following a trigger by the merchant terminal.

In step 1203, the payment request is sent to the merchant terminal. This may be done by the customer tapping mobile device 103 against the contactless interface of the merchant terminal.

In step 1204, the payment request is sent from the merchant terminal to an acquirer bank server. The acquirer bank handles the transactions for the merchant.

In step 1205, the payment request is sent from the acquirer bank server to platform 101.

In step 1206, platform 101 sends the payment request to bank server 102.

In step 1207, bank server 102 confirms that checking account 105 has sufficient funds to service the payment request, and approves the payment request and sends an approval confirmation to platform 101.

In step 1208, platform 101 sends the approval confirmation to the acquirer bank server.

In step 1209, the acquirer bank server sends the approval confirmation to the merchant terminal.

In step 1210, the merchant terminal responds to mobile device 103 that the payment request has been approved.

In step 1211, platform 101 sends a notification to mobile device 103 to inform the customer that a debit card payment has been made.

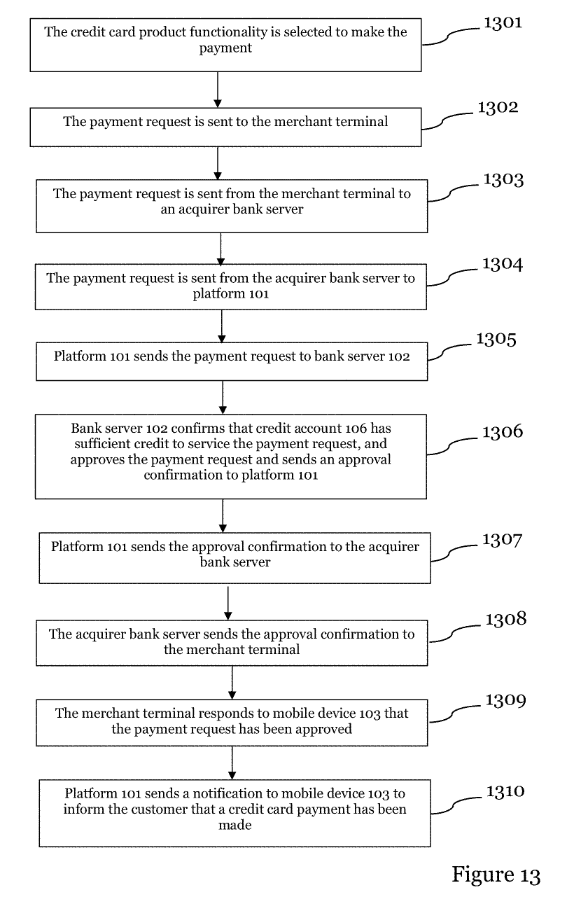

FIG. 13 shows an illustration of a customer using the credit card product functionality of digital card 104 to make payment.

In step 1301, the credit card product functionality is selected to make the payment. The credit card functionality may be selected by the customer. The customer's selection of the credit card product functionality could be done via the graphic representation of digital card 104 as described above. The customer may have decided to use the credit card product functionality as the payment amount is large. Alternatively, the credit card functionality may be selected following a trigger by other applications on mobile device 103 (for example, a geolocation application). Alternatively, the credit card functionality may be selected following a trigger by the merchant terminal.

In step 1302, the payment request is sent to the merchant terminal. This may be done by the customer tapping mobile device 103 against the contactless interface of the merchant terminal.

In step 1303, the payment request is sent from the merchant terminal to an acquirer bank server. The acquirer bank handles the transactions for the merchant.

In step 1304, the payment request is sent from the acquirer bank server to platform 101.

In step 1305, platform 101 sends the payment request to bank server 102.

In step 1306, bank server 102 confirms that credit account 106 has sufficient credit to service the payment request, and approves the payment request and sends an approval confirmation to platform 101.

In step 1307, platform 101 sends the approval confirmation to the acquirer bank server.

In step 1308, the acquirer bank server sends the approval confirmation to the merchant terminal.

In step 1309, the merchant terminal responds to mobile device 103 that the payment request has been approved.

In step 1310, platform 101 sends a notification to mobile device 103 to inform the customer that a credit card payment has been made.

Because digital card 104 is on client application on mobile device 103, digital card 104 would be able to interface with other applications on mobile device 103, for example, a geolocation application. A geolocation application is a software application which is able to ascertain the real-world location of mobile device 103. The geolocation application can use radio frequency location methods or any other geo-locating techniques known in the art to ascertain the geolocation of mobile device 103.

Knowing the real-world location of mobile device 103 in relation to known static locations like ATMs (automated teller machines) and retail shops, offers a myriad of implementation possibilities of using the geolocation information to enhance the features of the product functionalities in digital card 104. One such implementation could be in relation to the debit card product functionality which had been mentioned above, in that the customer can activate the “LOCATE ATMS” feature tab 601 to locate the ATMs in proximity to mobile device 103 or the ATMs within the vicinity.

Another implementation could be that if the geolocation information detects that mobile device 103 is in close proximity to an ATM, the debit card product functionality would automatically be selected. One possible reason for selecting the debit card product functionality on digital card 104 when in proximity of an ATM would be to withdraw cash. As some ATMs support Near Field Communication (NFC) based withdrawals or contactless withdrawals, once the debit card product functionality on digital card 104 has been selected, the customer can simply tap mobile device 103 on a NFC reader of the ATM to withdraw cash.

Another implementation could be that if the geolocation information detects that mobile device 103 is in a particular retail shop, and the customer has previously shopped in the retail shop before and had used the credit card product functionality, the credit card product functionality would automatically be selected. Another implementation could be the automatic selection of the gift card product functionality, the gift card product functionality being associated with the retail shop.

Another implementation could be that if the geolocation information detects that mobile device 103 is in a foreign country, the forex card product functionality would automatically be selected.

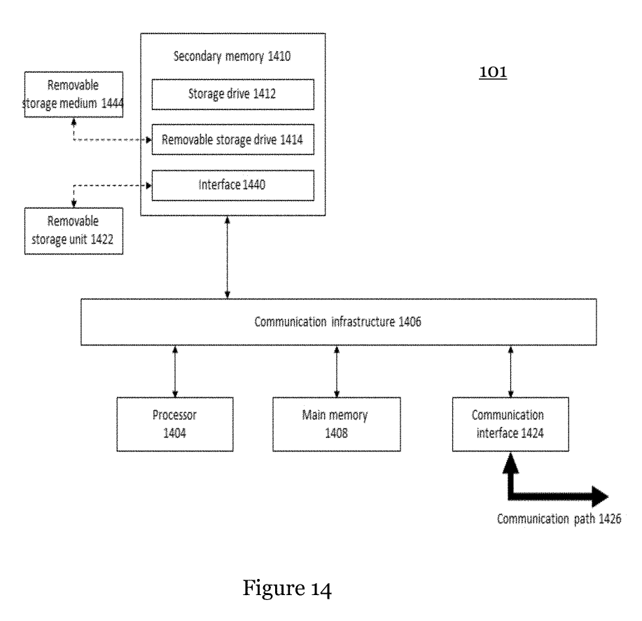

The following description of platform 101 is provided by way of example only and is not intended to be limiting. Platform 101 may comprise of a server or a plurality of servers. As shown in FIG. 14, the exemplary platform 101 includes a processor 1404 for executing software routines. Although a single processor is shown for the sake of clarity, platform 101 may also include a multi-processor system. The processor 1404 is connected to a communication infrastructure 1406 for communication with other components of platform 101. The communication infrastructure 1406 may include, for example, a communications bus, cross-bar, or network. Platform 101 further includes a main memory 1408, such as a random access memory (RAM), and a secondary memory 1410.

The secondary memory 1410 may include, for example, a storage drive 1412, which may be a hard disk drive, a solid state drive or a hybrid drive and/or a removable storage drive 1414, which may include a magnetic tape drive, an optical disk drive, a solid state storage drive (such as a USB flash drive, a flash memory device, a solid state drive or a memory card), or the like. The removable storage drive 1414 reads from and/or writes to a removable storage medium 1444 in a well-known manner. The removable storage medium 1444 may include magnetic tape, optical disk, non-volatile memory storage medium, or the like, which is read by and written to by removable storage drive 1414. As will be appreciated by persons skilled in the relevant art(s), the removable storage medium 1444 includes a computer readable storage medium having stored therein computer executable program code instructions and/or data. In an alternative implementation, the secondary memory 1410 may additionally or alternatively include other similar means for allowing computer programs or other instructions to be loaded into platform 101. Such means can include, for example, a removable storage unit 1422. Examples of a removable storage unit 1422 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1422 which allow software and data to be transferred from the removable storage unit 1422 to platform 101.

Platform 101 also includes at least one communication interface 1424. The communication interface 1424 allows software and data to be transferred between platform 101 and external devices via a communication path 1426. In various embodiments of the inventions, the communication interface 1424 permits data to be transferred between platform 101 and a data communication network, such as a public data or private data communication network. Examples of a communication interface 1424 can include a modem, a network interface (such as an Ethernet card), a communication port (such as a serial, parallel, printer, GPIB, IEEE 1394, RJ45, USB), an antenna with associated circuitry and the like. The communication interface 1424 may be wired or may be wireless. Software and data transferred via the communication interface 1424 are in the form of signals which can be electronic, electromagnetic, optical or other signals capable of being received by communication interface 1424. These signals are provided to the communication interface via the communication path 1426.

Software may be stored in a computer program product and loaded into platform 101 using the removable storage drive 1414, the storage drive 1412, or the interface 1440. Alternatively, the computer program product may be downloaded to platform 101 over the communications path 1426. The software, when executed by the processor 1404, causes platform 101 to perform functions of embodiments described herein. It is to be understood that the embodiment of FIG. 14 is presented merely by way of example. Therefore, in some embodiments one or more features of platform 101 may be omitted. Also, in some embodiments, one or more features of platform 101 may be combined together. Additionally, in some embodiments, one or more features of platform 101 may be split into one or more component parts.

As used herein, the term “computer program product” may refer, in part, to removable storage medium 1444, removable storage unit 1422, a hard disk installed in storage drive 1412, or a carrier wave carrying software over communication path 1426 (wireless link or cable) to communication interface 1424. Computer readable storage media refers to any non-transitory, non-volatile tangible storage medium that provides recorded instructions and/or data to platform 101 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of platform 101. Examples of transitory or non-tangible computer readable transmission media that may also participate in the provision of software, application programs, instructions and/or data to platform 101 include radio or infra-red transmission channels as well as a network connection to another computer or networked device, and the Internet or Intranets including e-mail transmissions and information recorded on Websites and the like.

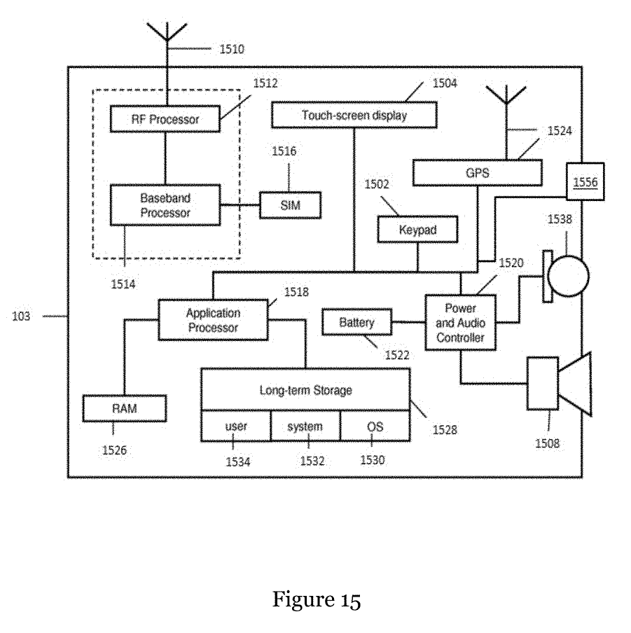

FIG. 15 is a schematic of an exemplary mobile device 103. Mobile device 103 comprises keypad 1502, touch-screen display 1504, microphone 1538, speaker 1508 and antenna 1510. Mobile device 103 is capable of being operated by a customer to perform a variety of different functions, such as, for example, hosting a telephone call, sending an SMS message, browsing the Internet, sending an email and providing satellite navigation. Mobile device 103 comprises hardware to perform communication functions (e.g. telephony, data communication), together with an application processor and corresponding support hardware to enable the wireless device have other functions, such as, messaging, Internet browsing, email functions and the like. The communication hardware is represented by RF processor 1512 which provides an RF signal to the antenna 1510 for the transmission of data signals, and the receipt therefrom. For example, mobile device 103 can send data to, and receive data from platform 101 via antenna 1510. Additionally provided is baseband processor 1514, which provides signals to and receives signals from RF Processor 1512. Baseband processor 1514 also interacts with a subscriber identity module 1516, as is well known in the art. The communication subsystem enables mobile device 103 to communicate via a number of different communication protocols including 3G, 4G, GSM, WiFi, Wi-fi direct, Near Field Communication (NFC), Bluetooth™ and/or CDMA.

Keypad 1502 and touch-screen display 1504 are controlled by application processor 1518. Power and audio controller 1520 is provided to supply power from battery 1522 to the communication subsystem, application processor 1518, and the other hardware. Power and audio controller 1520 also controls input from microphone 1538, and audio output via speaker 1508. Also provided is global positioning system (GPS) antenna and associated receiver element 1524 which is controlled by application processor 1518 and is capable of receiving a GPS signal for use with a satellite navigation functionality of mobile device 103.

In order for the application processor 1518 to operate, various different types of memory are provided. Firstly, mobile device 103 includes Random Access Memory (RAM) 1526 connected to application processor 1518 into which data and program code can be written and read from at will. Code placed anywhere in RAM 1526 can be executed by application processor 1518 from RAM 1526. RAM 1526 represents a volatile memory of mobile device 103. Secondly, mobile device 103 is provided with long-term storage 1528 connected to application processor 1518. Long-term storage 1528 comprises three partitions, an operating system (OS) partition 1530, system partition 1532 and user partition 1534. Long-term storage 1528 represents a non-volatile memory of mobile device 103.

In the present example, OS partition 1530 contains the firmware of mobile device 103 which includes an operating system. Other computer programs may also be stored on long-term storage 1528, such as application programs, and the like. In particular, application programs which are mandatory to mobile device 103, such as, in the case of a smartphone, communications applications and the like are typically stored in system partition 1532. The application programs stored on system partition 1532 would typically be those which are bundled with mobile device 103 by the device manufacturer when mobile device 103 is first sold. Application programs which are added to mobile device 103 by the customer would usually be stored in user partition 1534. For example, the client application can be stored in user partition 1534. As stated, the representation of FIG. 15 is schematic. In practice, the various functional components illustrated may be substituted into one and the same component. For example, long-term storage 1528 may comprise NAND flash, NOR flash, a hard disk drive or a combination of these. Mobile device 103 may also have an image capturing module 1556. Image capturing module 1556, together with a suitable application, may be used to capture/scan QR codes and process the data embedded in the QR code.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A computer implemented method for adding a new product functionality to a customer's digital card, the digital card having an existing product functionality, the digital card having been provisioned on a client application installed on a mobile device, and the digital card having a primary account number stored at a server, the method comprising the steps of:
creating with a platform, an association between the primary account number of the digital card and an account associated with the new product functionality;
setting with the platform, configuration parameters in the server in relation to the primary account number of the digital card to activate a primary feature associated with the new product functionality, the primary feature associated with the new product functionality capable of initiating data access to the account associated with the new product functionality; and
initiating with the platform, an update to the client application on the mobile device such that the digital card is provided with the primary feature associated with the new product functionality.

2. The method of claim 1, further comprising the steps of:
setting with the platform, configuration parameters in the server in relation to the primary account number of the digital card to activate at least one auxiliary feature associated with the new product functionality, the at least one auxiliary feature associated with the new product functionality capable of initiating data access to the account associated with the new product functionality; and
initiating with the platform, another update to the client application on the mobile device such that the digital card is provided with the at least one auxiliary feature associated with the new product functionality.

3. The method of claim 1, wherein the client application is a digital wallet application.

4. The method of claim 1, wherein the new product functionality is any one of the following: debit card product functionality, credit card product functionality, forex card product functionality, prepaid card product functionality, transit card product functionality, loyalty card product functionality, gift card product functionality and corporate card product functionality.

5. The method claim 1, further comprising the step of accessing the account associated with the new product functionality to retrieve data, in response to a selection of a feature tab on a product functionality interface rendered on a display interface of the mobile device.

6. The method of claim 5, further comprising the step of sending the retrieved data to the mobile device for display on the display interface.

7. A platform for adding a new product functionality to a customer's digital card, the digital card having an existing product functionality, the digital card having been provisioned on a client application installed on a mobile device, and the digital card having a primary account number stored in a server, the platform comprising at least one processor configured to:
create an association between the primary account number of the digital card and an account associated with the new product functionality;
set configuration parameters in the server in relation to the primary account number of the digital card, to activate a primary feature associated with the new product functionality, the primary feature associated with the new product functionality capable of initiating data access to the account associated with the new product functionality; and
initiate an update to the client application on the mobile device such that the digital card is provided with the primary feature associated with the new product functionality.

8. The platform of claim 7, wherein the at least one processor is further configured to:
set configuration parameters in the server in relation to the primary account number of the digital card, to activate at least one auxiliary feature associated with the new product functionality, the at least one auxiliary feature associated with the new product functionality capable of initiating data access to the account associated with the new product functionality; and
initiate another update to the client application on the mobile device such that the digital card is provided with the at least one auxiliary feature associated with the new product functionality.

9. The platform of claim 7, wherein the client application is a digital wallet application.

10. The platform of claim 7, wherein the new product functionality is any one of the following: debit card product functionality, credit card product functionality, forex card product functionality, prepaid card product functionality, transit card product functionality, loyalty card product functionality, gift card product functionality and corporate card product functionality.

11. The platform of claim 7, wherein the at least one processor is further configured to access the account associated with the new product functionality to retrieve data, in response to a selection of a feature tab on a product functionality interface rendered on a display interface of the mobile device.

12. The platform of claim 11, wherein the at least one processor is further configured to send the retrieved data to the mobile device for display on the display interface.

13. A non-transitory computer-readable storage medium having instructions stored thereon which, when executed by one or more computer processors, cause a mobile computing device to execute an update process for receiving a new product functionality for a customer's digital card having an existing product functionality and having been provisioned on a client application installed on the mobile device, the update process comprising:
receiving an update on the client application from a platform such that the digital card is provided with a primary feature associated with the new product functionality, the primary feature associated with the new product functionality having been activated by the setting of configuration parameters in a server in relation to a primary account number of the digital card, wherein the primary account number is stored in the server, and wherein the primary feature associated with the new product functionality is capable of initiating data access to an account associated with the new product functionality.

14. The non-transitory computer-readable storage medium according to claim 13, wherein the update process comprises:
receiving another update on the client application from the platform such that the digital card is provided with at least one auxiliary feature associated with the new product functionality, the at least one auxiliary feature associated with the new product functionality having been activated by the setting of configuration parameters in the server in relation to the primary account number of the digital card, wherein the at least one auxiliary feature associated with the new product functionality is capable of initiating data access to the account associated with the new product functionality.

15. The non-transitory computer-readable storage medium according to claim 13, wherein the client application is a digital wallet application.

16. The non-transitory computer-readable storage medium of claim 13, wherein the new product functionality is any one of the following: debit card product functionality, credit card product functionality, forex card product functionality, prepaid card product functionality, transit card product functionality, loyalty card product functionality, gift card product functionality and corporate card product functionality.

17. The non-transitory computer-readable storage medium of claim 16, wherein the update process comprises:
obtaining geolocation data; and
automatically selecting the new product functionality based on the geolocation data.

18. The non-transitory computer-readable storage medium of claim 17, wherein the geolocation data indicates that the mobile device is approaching an ATM (automated teller machine), and the new product functionality selected is the debit card product functionality.

19. The non-transitory computer-readable storage medium of claim 17, wherein the geolocation data indicates that the mobile device is in a foreign country, and the new product functionality selected is the forex card product functionality.

20. The non-transitory computer-readable storage medium of claim 17, wherein the geolocation data indicates that the mobile device is approaching a retail shop and the new product functionality selected is the gift card product functionality, the gift card product functionality being associated with the retail shop.
